(19) United States
(12) Patent Application Publication
(10) Pub. No.: US 2013/0111004 A1
(43) Pub. Date: May 2, 2013

(54) File manager having an HTTP-based user interface

(71) Applicant: Akamai Technologies, Inc., Cambridge, MA (US)

(72) Inventor: James Mutton, Maple Valley, WA (US)

(73) Assignee: AKAMAI TECHNOLOGIES, INC., Cambridge, MA (US)

(21) Appl. No.: 13/666,087

(22) Filed: Nov. 1, 2012

Related U.S. Application Data
(60) Provisional application No. 61/554,871, filed on Nov. 2, 2011.

(51) Int. Cl. G06F 15/173

(52) U.S. Cl. 709/223

(57) ABSTRACT

A shared computing infrastructure has associated therewith a storage system, and a portal application through which portal users access the shared computing infrastructure and provision services. A method for file management in the infrastructure begins by associating, in a database, a portal user to one or more users of the storage system. Upon authentication of the portal user, authority to perform storage management operations with respect to at least one storage group is then automatically delegated from the portal user to the users of the storage system. A user of the storage system (who has received the delegated authority) is then provided a web-based user interface from within the portal application itself. In response to receipt of information from the user interface, and without requiring an additional credential to be entered by the user, at least one storage management operation is then performed from within the portal application.

This application is based on and claims priority to Ser. No. 61/554,871, filed Nov. 2, 2011.

### BACKGROUND OF THE INVENTION

1. Technical Field

This application relates generally to management of content in a shared infrastructure.

2. Brief Description of the Related Art

Distributed computer systems are well-known in the prior art. One such distributed computer system is a “content delivery network” or “CDN” that is operated and managed by a service provider. The service provider typically provides the content delivery service on behalf of third parties (customers) who use the service provider's infrastructure. A distributed system of this type typically refers to a collection of autonomous computers linked by a network or networks, together with the software, systems, protocols and techniques designed to facilitate various services, such as content delivery, web application acceleration, or other support of outsourced origin site infrastructure. A CDN service provider typically provides service delivery through digital properties (such as a website), which are provisioned in a customer portal and then deployed to the network. A digital property typically is bound to one or more edge configurations that allow the service provider to account for traffic and bill its customer.

The customer portal is typically web-based and configured as an extranet configuration application by which users authorized by a CDN customer access and provision their services. One such service is the storage and delivery of digitized files, software, video, or other large objects. Customers who use the CDN shared infrastructure for this purpose typically require the ability to manage their content files. As used herein, file management typically refers to the ability to list, move, delete and upload files, as well as to create and remove directories in which the customer's content is stored. A CDN portal application (the “portal”) typically is implemented as a distributed, secure application comprising a web server-based front-end, one or more application servers, one or more database servers, a database, and other security, administrative and management components.

### BRIEF SUMMARY

A shared computing infrastructure has associated therewith a storage system, and a portal application through which portal users access the shared computing infrastructure and provision one or more services, such as content storage and delivery. A representative shared computing infrastructure is a content delivery network (CDN). According to this disclosure, the infrastructure includes a File Manager application that provides a streamlined, easy-to-use, web-based interface to the CDN distributed storage file system (“Storage”) for CDN customers. The File Manager preferably interfaces to an existing Storage Content Management System (CMS) Application Programming Interface (API). Preferably, File Manager accesses the CMS API directly, advantageously removing the requirement of a proxy of all activity through the customer portal. This prevents unnecessary load on the portal infrastructure, freeing up other resources. In operation, the File Manager creates a configurable link between portal users and storage users so that a simplified workflow can be created and enforced. In particular, using this workflow preferably storage users are not required to re-login once a portal user-to-storage user relationship has been established.

In one embodiment, a method for file management in the shared computing infrastructure begins by associating, in a database, a portal user to one or more users of the storage system. Upon authentication of the portal user, authority to perform one or more storage management operations with respect to at least one storage group is then automatically delegated from the portal user to the one or more users of the storage system. A user of the storage system (who has received the delegated authority) is then provided a web-based user interface from within the portal application itself. In response to receipt of information from the web-based user interface, and without requiring an additional credential to be entered by a user of the storage system, at least one storage management operation is then performed from within the portal application.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a block diagram illustrating a known distributed computer system configured as a content delivery network (CDN);

FIG. 2 is a representative CDN edge machine configuration;

FIG. 3 illustrates an overview of the File Manager operation;

FIG. 4 illustrates an action sequence for the File Manager application;

FIG. 5 illustrates a basic workflow for file operations using the File Manager;

FIG. 6 illustrates an authentication method implemented by the File Manager;

FIG. 7 illustrates further details of the authentication method; and

FIG. 8 illustrates an example portal user-to-storage user mapping according to this disclosure.

### DETAILED DESCRIPTION

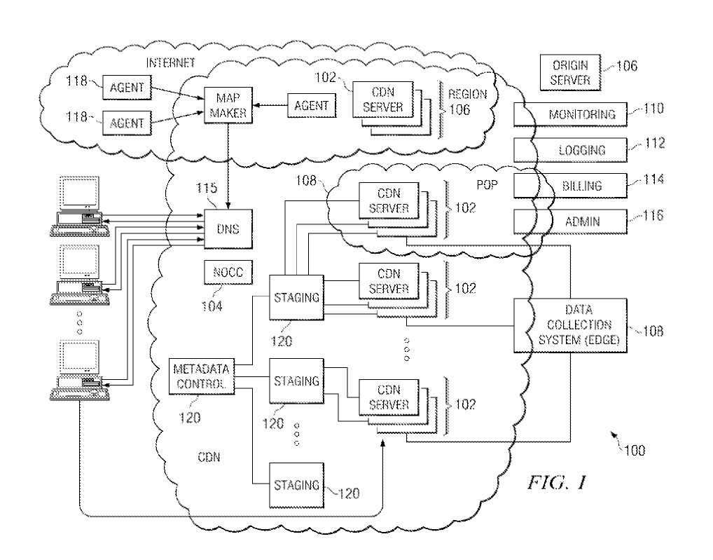

FIG. 1 illustrates a known distributed computer system (a shared infrastructure) for storage of and delivery of content (digitized files) on behalf of customers of that shared infrastructure. As will be described herein, the shared infrastructure includes a file management solution (referred to as the “File Manager”) that facilitates upload and storage of a customer's files to a back-end storage system (referred to as “Storage”) associated with (or comprising part of) the shared infrastructure.

In a known system, such as shown in FIG. 1, a distributed computer system 100 is configured as a CDN and is assumed to have a set of machines 102a-n distributed around the Internet. Typically, most of the machines are servers located near the edge of the Internet, i.e., at or adjacent end user access networks. A network operations command center (NOCC) 104 manages operations of the various machines in the system. Third party sites, such as web site 106, offload delivery of content (e.g., HTML, embedded page objects, streaming media, software downloads, and the like) to the distributed computer system 100 and, in particular, to “edge” servers. Typically, content providers offload their content delivery by aliasing (e.g., by a DNS CNAME) given content provider domains or sub-domains to domains that are managed by the service provider's authoritative domain name service. End users that desire the content are directed to the distributed computer system to obtain that content more reliably and efficiently. Although not shown in detail, the distributed computer system may also include other infrastructure, such as a distributed data collection system 108 that collects usage and other data from the edge servers, aggregates that data across a region or set of regions, and passes that data to other back-end systems 110, 112, 114 and 116 to facilitate monitoring, logging, alerts, billing, management and other operational and administrative functions. Distributed network agents 118 monitor the network as well as the server loads and provide network, traffic and load data to a DNS query handling mechanism 115, which is authoritative for content domains being managed by the CDN. A distributed data transport mechanism 120 may be used to distribute control information (e.g., metadata to manage content, to facilitate load balancing, and the like) to the edge servers.

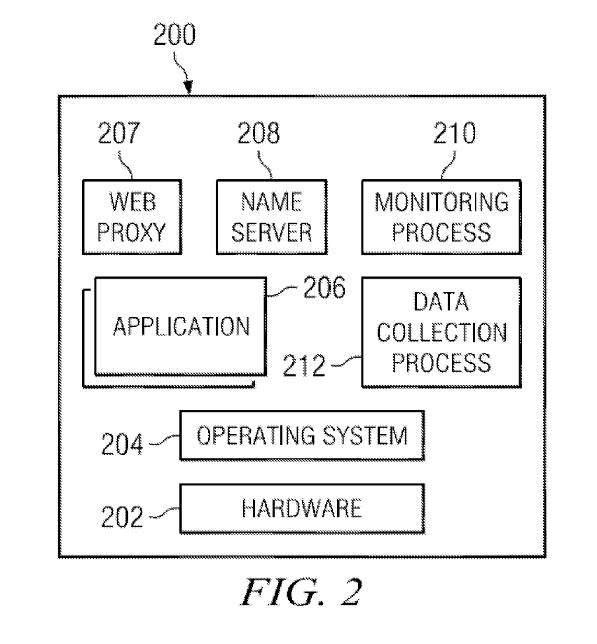

As illustrated in FIG. 2, a given machine 200 comprises commodity hardware (e.g., an Intel Pentium processor) 202 running an operating system kernel (such as Linux or variant) 204 that supports one or more applications 206a-n. To facilitate content delivery services, for example, given machines typically run a set of applications, such as an HTTP proxy 207 (sometimes referred to as a “global host” or “ghost” process), a name server 208, a local monitoring process 210, a distributed data collection process 212, and the like. For streaming media, the machine typically includes one or more media servers, such as a Windows Media Server (WMS) or Flash server, as required by the supported media formats.

A CDN edge server is configured to provide one or more extended content delivery features, preferably on a domain-specific, customer-specific basis, preferably using configuration files that are distributed to the edge servers using a configuration system. A given configuration file preferably is XML-based and includes a set of content handling rules and directives that facilitate one or more advanced content handling features. The configuration file may be delivered to the CDN edge server via the data transport mechanism. U.S. Pat. No. 7,111,057 illustrates a useful infrastructure for delivering and managing edge server content control information, and this and other edge server control information can be provisioned by the CDN service provider itself, or (via an extranet or the like) the content provider customer who operates the origin server.

The CDN includes or has associated therewith a storage subsystem, such as described in U.S. Pat. No. 7,472,178, the disclosure of which is incorporated herein by reference. A representative storage site in this context is a collection of one of more storage “regions,” typically in one physical location. In this subsystem, preferably content (e.g., a customer's digital files) is replicated across storage sites. In one embodiment, a storage region comprises a collection of client servers that share a back-end switch, and a set of file servers (e.g., NFS servers) which, together with a network file system, provide raw storage to a set of content upload, download and replication services provided by the client servers. Preferably, the NFS servers export the network file system to the client servers. At least some of the client servers execute upload (e.g., FTP) processes, and at least some of the client servers execute download (e.g., HTTP) processes. Preferably, each of the client servers executes a replication engine, which provides overall content management for the storage site. Content upload is a service that allows a content provider to upload content to the storage site. Content replication is a service that ensures that content uploaded to a given storage site is replicated to a set of other storage sites (each a “replica” or “replica site”) to increase content availability and improve performance. Preferably, content is replicated across multiple storage sites according to per-customer configuration information. Content download is a service that allows content to be accessed by an entity, e.g., via an edge server, that makes a given request. Thus, in an illustrative embodiment, a storage site preferably comprises a network file system, and a set of NFS servers that export the network file system to a set of client servers. The file servers may be CDN-owned and operated or outsourced. One possible deployment uses outsourced storage, such as storage available from a storage service provider (SSP). A managed storage service of this type typically comprises two or more storage sites, each of which may comprise above-described implementation.

The above-described storage sub-system is merely exemplary, and it should not be taken to limit this disclosure.

The CDN also may operate a server cache hierarchy to provide intermediate caching of customer content; one such cache hierarchy subsystem is described in U.S. Pat. No. 7,376,716, the disclosure of which is incorporated herein by reference.

The CDN may provide secure content delivery among a client browser, edge server and customer origin server in the manner described in U.S. Publication No. 20040093419. Secure content delivery as described therein enforces SSL-based links between the client and the edge server process, on the one hand, and between the edge server process and an origin server process, on the other hand. This enables an SSL-protected web page and/or components thereof to be delivered via the edge server.

As an overlay, the CDN resources may be used to facilitate wide area network (WAN) acceleration services between enterprise data centers (which may be privately-managed) and third party software-as-a-service (SaaS) providers.

In a typical operation, a content provider identifies a content provider domain or sub-domain that it desires to have served by the CDN. The CDN service provider associates (e.g., via a canonical name, or CNAME) the content provider domain with an edge network (CDN) hostname, and the CDN provider then provides that edge network hostname to the content provider. When a DNS query to the content provider domain or sub-domain is received at the content provider's domain name servers, those servers respond by returning the edge network hostname. The edge network hostname points to the CDN, and that edge network hostname is then resolved through the CDN name service. To that end, the CDN name service returns one or more IP addresses. The requesting client browser then makes a content request (e.g., via HTTP or HTTPS) to an edge server associated with the IP address. The request includes a host header that includes the original content provider domain or sub-domain. Upon receipt of the request with the host header, the edge server checks its configuration file to determine whether the content domain or sub-domain requested is actually being handled by the CDN. If so, the edge server applies its content handling rules and directives for that domain or sub-domain as specified in the configuration. These content handling rules and directives may be located within an XML-based “metadata” configuration file.

As noted above, the CDN service provider provides a secure customer portal that is web-based and configured as an extranet configuration application. The portal is the usual way in which users authorized by a CDN customer access and provision their services. One such service is the storage and delivery of digitized files, software, video, or other large objects. Customers who use the CDN shared infrastructure for this purpose typically require the ability to manage their content files. As used herein, and as noted above, file management typically refers to the ability to list, move, delete and upload files, as well as to create and remove directories in which the customer's content is stored. A CDN portal application (the “portal”) typically executes on one or more machines, wherein a machine comprises hardware (CPU, disk, memory, network interfaces, other I/O), operating system software, applications and utilities. The portal typically is implemented as a distributed, secure application comprising a web server-based front-end, one or more application servers, one or more database servers, a database, and other security, administrative and management components.

An edge server process may need to contact an intermediate server to retrieve user information before going forward to an origin server. An intermediate processing agent (IPA) may be used for this purpose. An IPA request is an internal (within the CDN) request having a response that may be cacheable. Control over the IPA function may be implemented in edge server metadata.

### File Manager

With the above as background, the subject matter of this disclosure is now described.

As described herein, the File Manager application provides a streamlined, easy-to-use, web-based interface to the CDN distributed storage file system (described below as “Storage”) for CDN customers. The File Manager preferably interfaces to an existing Storage Content Management System (CMS) Application Programming Interface (API). Preferably, File Manager accesses the CMS API directly, advantageously removing the requirement of a proxy of all activity through the customer portal. This prevents unnecessary load on the portal infrastructure, freeing up other resources. As will be seen, the File Manager creates a configurable link between portal users and storage users so that a simplified workflow can be created and enforced. Customers are not required to re-login once a portal user-to-storage user relationship has been established.

By way of background, consider the following use case. CompanyX has an agreement with the CDN to deliver media assets over an HTTP-based progressive download service. An administrator of the agreement makes a configuration update in the customer portal to enable File Manager and specifies in a portal-user manager that the Portal User bob@companyx.com will access Storage (NS) over File Manager using the Storage user companyx_bob. Each day Bob is required to upload media files (that will be delivered to end users by the CDN) delivered to him on a DVD by his post-production department. To use File Manager, Bob logs in to the portal and navigates to the File Manager application. The File Manager application loads a user interface that lists the files and directories in a root of the CompanyX Storage. Bob navigates to a sub-directory that again lists the files and directories of the current folder. Bob then creates a new directory for the current media files and navigates into the current directory. Bob clicks a button to upload a file, selects a several GB file from his local machine and begins uploading. Without having to wait, Bob clicks the upload button again, selects another large file and begins uploading that file as well.

The File Manager application thus provides a web-based user interface from within the customer extranet portal to a customer's Storage group. The user interface (UI) functions exposed include list, move, delete, upload, create directory, remove directory. The File Manager application preferably uses Storage token-based authentication to evaluate actions based on the permissions of a Storage user. The File Manager application preferably does not require entry of additional credentials to access Storage.

The File Manager traffic preferably occurs over SSL or other secure transport. The File Manager application preferably does not transfer file through the portal infrastructure.

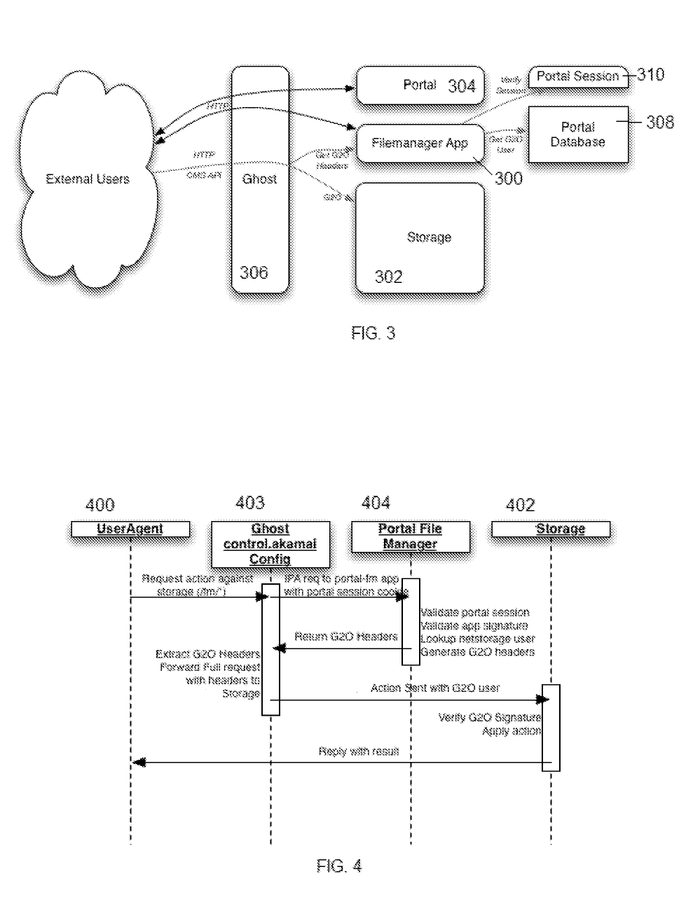

As seen in FIG. 3, in one embodiment, the File Manager application 300 is a HTML/JavaScript user-interface to Storage 302, delivered through a portal (extranet) 304 infrastructure. In particular, the File Manager application 300 allows a user with contract-administrative privileges to configure a one-to-many mapping between portal users (pusers), on the one hand, and Storage users (nusers), on the other hand. This mapping creates a delegation of Storage authentication for the given nuser to the portal when the specified puser logs in. When a puser navigates to the File Manager application in the portal, the user will retrieve from the database and list the Storage Groups the user has been configured to enable access using File Manager. Preferably, no other information about the Storage file system is stored in the portal infrastructure. The remaining information of interest (such as the list of files/directories and the result of file operations) preferably comes directly from the Storage CMS (Content Management System) API.

As shown in FIG. 3, Ghost 306 refers to an edge server web proxy. The portal is the extranet portal application provided by the CDN service provider, and Storage refers to a distributed storage system or sub-system, such as described in the above-identified U.S. patent, the disclosure of which is incorporated by reference. Ghost may communicate with File Manager using an IPA, or other native code functions.

As shown in FIG. 4, when the user 400 (through his or her user agent, typically a web browser) accesses Storage 402 (such as browsing to a directory listing), the user's browser contacts a given domain (in this example, the representative domain control.akamai.com), preferably using a path that initiates a specialized workflow in Ghost metadata. When doing so, the browser includes a query string value that is passed to the browser by the File Manager application 404 and stored on the user's session. The puser's control.akamai.com session cookie is also forwarded, preferably over secure transport request, to a File Manager where it is validated, e.g., against the portal session infrastructure. Assuming the session is valid and that File Manager now knows the puser making the request, it can contact the portal database (see 308 in FIG. 3) to identify the appropriate Storage user and pre-configured ghost-to-origin server (a customer-specific) secret to properly access Storage's CMS API. It knows this by examining the puser-to-nuser mapping previously created by a contract-administrator. Once File Manager has the ghost-to-origin (G2O) parameters for the correct nuser to use, it generates an appropriate action header and responds with that header to Ghost's secure transport request. Ghost then applies the headers returned in the request to a go-forward request to Storage's CMS API.

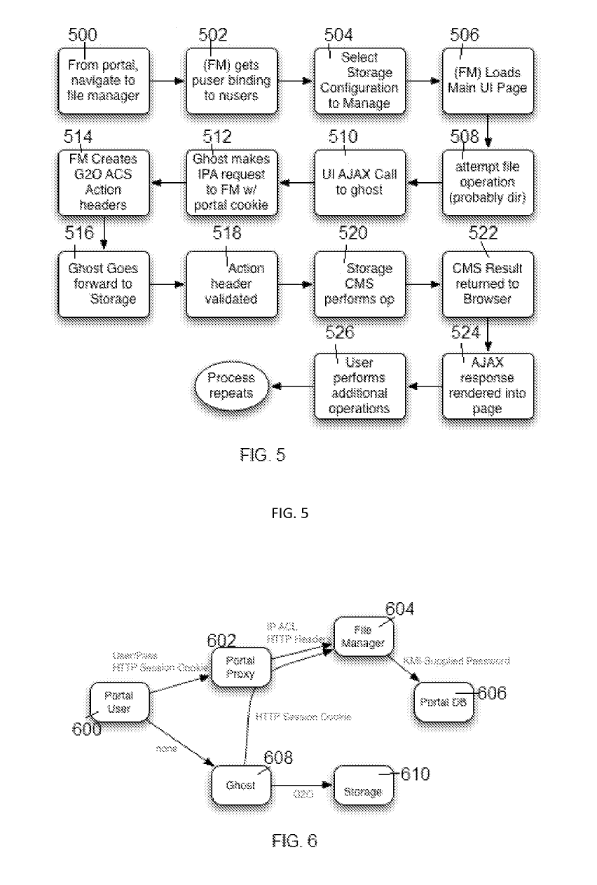

FIG. 5 illustrates the typical workflow within File Manager for file operations. At step 500, and from the portal, a user navigates to the File Manager. At step 502, the File Manager retrieves the portal user-to-storage user binding that was previously created. At step 504, File Manager uses this information to select the proper Storage configuration to manage. At step 506, File Manager then loads the main user interface page for this selected configuration. At step 508, the user (from his or her web browser) attempts a file operation, such as to access a file directory. In response, at step 510, the File Manager UI makes an AJAX-based call to an edge server ghost process to which the UI has been mapped. Ghost then makes a request to the File Manager using a portal cookie. This is step 512, and it may use an intermediate processing agent (IPA) for this purpose. At step 514, File Manager creates a ghost-to-origin (G2O) Storage action header. Ghost then goes forward to Storage at 516, and Storage validates the header at step 518. At step 520, Storage CMS performs the operation requested. The results are returned by CMS to the browser at step 522. At step 524, an AJAX response is rendered into the page. As additional operations are perform (step 526), the process repeats.

The following provides additional details regarding the File Management component. In one embodiment, File Manager is a portal application created in Java. The portal framework itself may be used to deliver pages to authenticated users. Preferably, the portal application contains just a relatively small number of pages, while general interactions with the Storage CMS API through Ghost is implemented via client-side technologies, such as JavaScript and Flash, AJAX, and the like (as described in the FIG. 5 example scenario). In this embodiment, and as noted above, preferably the File Manager component is responsible for authenticating requests and generating action headers for file operations made directly to Storage by the File Manager Javascript, through Ghost (the edge server proxy). Any information that needs to be persisted by the File Manager application preferably is persisted to the portal database or portal session storage (see 310 in FIG. 3).

Because the File Manager application preferably runs from the portal, it is delivered over SSL. Preferably, all file operations (and therefore all communication of the portal session-cookie) also occur over SSL. In one embodiment, File Manager accesses the CMS API through AJAX on a given domain (e.g., control.akamai.com), so all CMS interactions also are encrypted over SSL.

Preferably, there are several authentication actors and methods involved during various stages of the overall process. FIG. 6 illustrates these actors and methods. As noted above, the Storage system 610 is accessed by an edge server ghost process 608. In this example embodiment, portal user authentication preferably is handled by portal-based authentication, which typically is a shared-secret or two-factor authentication process depending on the user's configuration. The end result is a session-cookie being stored in the user's browser 600. This session cookie typically references a session stored in the portal network in a cache (or other memory), which contains the user's identity and authorization. Preferably, a portal proxy 602 (e.g., a web server that provides portal pages) does not allow communication to the internal application tier without this session being present and validated to the session store. The File Manager 604 preferably redirects all connections without the appropriately signed headers produced by the portal proxy and/or without a valid portal session. The File Manager application may use portal libraries or other code functions to manage this stage and determine if the user is authorized to access the application. As described, the File Manager application maintains an association of pusers-to-nusers in the portal database 606. This association preferably requires contract-level-administrator privileges to create/alter. Preferably, a successful authentication for a portal user (puser) automatically grants authentication to all associated Storage users (nusers), but within the File Manager application only.

As seen in FIG. 7, when a File Operation request comes to portal proxy 702 from the portal user 700, that connection is unauthenticated (although it is encrypted via SSL), however, it does carry the Portal session cookie and a File Manager application signature. The ghost forward request to the portal File Manager 704 preferably includes this cookie and is thus authenticated to the portal proxy and to the File Manager Application. The File Manager application also checks (using the portal database 706) that the application signature matches the value stored in the session and delivered through rendering of the File Manager UI. The File Manager application generates a ghost-to-origin (G2O) header in the response, using the path to determine the appropriate Storage user (nuser) to apply (or fails authentication if no nuser can be determined). Ghost then authenticates to Storage using the G2O headers supplied by File Manager. The authentication is evaluated by Storage based on the user applied through the G2O token.

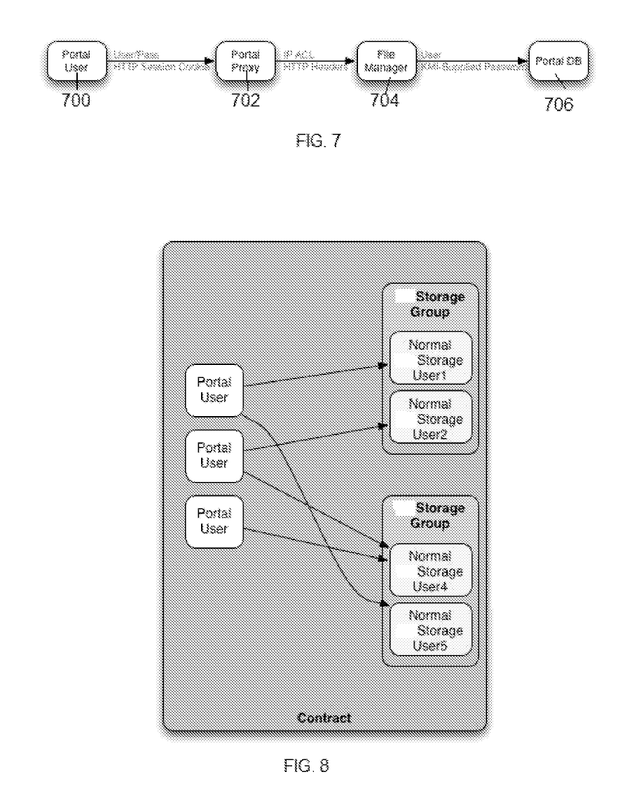

As seen in FIG. 8, typically portal users have a many-to-many relationship with Storage groups but a many-to-one relationship with individual Storage Users with in a single Storage group. Preferably, all Storage Users used for File Manager are enabled for G2O. Preferably, all CMS commands are applied to Storage using GSO headers of the portal user as their respective Storage User. Storage remains unaware of portal users. Preferably, and as described above, G2O headers are generated and given to ghost in an IPA request to File Manager.

Provisioning File Manager typically involves some steps that preferably are done only once for each customer and some steps that may be required to be repeated for updates to a customer's configuration. The basic steps that are carried out one time include creating a record in the database to enable the File Manager application, creating at least one association between at least one portal user (puser) and one or more Storage users (nusers) (see FIG. 8), and creating the ghost-to-origin (G2O) configuration for applicable nusers and storing the G2O secret in the database. This secret should be encrypted but otherwise accessible to the File Manager application. Steps that may be repeated include creating an association between pusers and nusers, and creating the G2O configuration for applicable nusers and storing the G2O secret in the database. Deprovisioning (apart from updates to enable/disable certain users or storage groups) is essentially the inverse process from provisioning.

The above-identified scheme may be used in other operating environments in which end users upload content (even user-generated content) via a front-end web-based interface and where such content is desired to be stored in a back-end storage system. Thus, for example, another use case might be a commercial web site that exports a web-based front-end (e.g., a set of web pages) that comprise a conventional web-based front-end to a back-end storage system for the uploaded content. In such case, the File Manager as described provides a web-based user interface within the front-end application to a customer's (or third party) back-end storage system.

In a representative implementation, the subject functionality is implemented in software, as computer program instructions executed by a processor.

More generally, the techniques described herein are provided using a set of one or more computing-related entities (systems, machines, processes, programs, libraries, functions, or the like) that together facilitate or provide the described functionality described above. In a typical implementation, a representative machine on which the software executes comprises commodity hardware, an operating system, an application runtime environment, and a set of applications or processes and associated data, that provide the functionality of a given system or subsystem. As described, the functionality may be implemented in a standalone machine, or across a distributed set of machines. The functionality may be provided as a service, e.g., as a SaaS solution.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the disclosed subject matter has been described in the context of a method or process, the subject disclosure also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus. While given components of the system have been described separately, one of ordinary skill will appreciate that some of the functions may be combined or shared in given instructions, program sequences, code portions, and the like.

Preferably, the functionality is implemented in an application layer solution, although this is not a limitation, as portions of the identified functions may be built into an operating system or the like.

The functionality may be implemented with other application layer protocols besides HTTP, such as HTTPS, or any other protocol having similar operating characteristics.

There is no limitation on the type of computing entity that may implement the client-side or server-side of the connection. Any computing entity (system, machine, device, program, process, utility, or the like) may act as the client or the server.

What is claimed is as follows:

1. A method of managing files in a shared computing infrastructure, the computing infrastructure having associated therewith a storage system in which files are stored, and a portal application through which portal users access the shared computing infrastructure and provision one or more services, the method comprising:
associating, in a database, a portal user to one or more users of the storage system;
upon authentication of the portal user, delegating authority from the portal user to the one or more users of the storage system for one or more storage management operations with respect to at least one storage group;
providing a user of the storage system, from within the portal application, a web-based user interface to the storage group, the user of the storage system having received the delegated authority; and
responsive to receipt of information from the web-based user interface, and without requiring an additional credential to be entered by a user of the storage system, performing at least one storage management operation from within the portal application.

2. The method as described in claim 1 wherein the one or more storage management operations are one of: list, move, delete and upload files, and create and remove directories.

3. The method as described in claim 1 further including enforcing a token-based authentication scheme to evaluate whether an action associated with the storage management operation is permissible based on at least permission of the user of the storage system.

4. The method as described in claim 1 wherein the web-based user interface is provided from the portal application over a secure link.

5. The method as described in claim 1 wherein the at least one storage management operation is a file upload and the method further includes receiving the file upload in the storage system for storage in the storage group.

6. The method as described in claim 5 wherein the file upload to the storage system use an edge server associated with the shared computing infrastructure.

7. The method as described in claim 1 wherein the shared computing infrastructure is a content delivery network (CDN).

8. The method as described in claim 1 wherein the storage system is a distributed storage file system having a content management system (CMS) application programming interface through which the at least one storage management operation is executed.

9. Apparatus associated with a shared computing infrastructure, the shared computing infrastructure having associated therewith a storage system, and a portal application through which portal users access the shared computing infrastructure and provision one or more services, the apparatus comprising:
a processor;
computer memory holding computer program instructions executed by the processor, the computer program instructions comprising:
code to create a link between a portal user and one or more users of the storage system with respect to at least one storage group;
code operative upon login of the portal user to provide, to a user of the storage system, a web-based user interface, the web-based user interface being provided from within the portal application, the web-based user interface being provided without requiring the user of the storage system to enter an additional credential; and
code responsive to receipt of information in the web-based user interface from the user of the storage system to perform at least one storage management operation with respect to the storage group.
